(19) United States
(12) Patent Application Publication
(10) Pub. No.: US 2026/0255385 A1
(43) Pub. Date: Aug. 27, 2026

(54) COORDINATED SPATIAL REUSE USING TXOP ALLOCATION BY A TXOP-HOLDING ACCESS POINT

(71) Applicant: Cisco Technology, Inc., San Jose, CA (US)

(72) Inventors: Brian Donald Hart, Los Altos Hills, CA (US); Malcolm Muir Smith, Richardson, TX (US); Binita Gupta, San Diego, CA (US)

(21) Appl. No.: 19/545,799

(22) Filed: Feb. 20, 2026

Related U.S. Application Data
(60) Provisional application No. 63/761,306, filed on Feb. 21, 2025.

(51) Int. Cl. H04W 74/04; H04W 74/00

(52) U.S. Cl. CPC H04W 74/04; H04W 74/002

(57) ABSTRACT

In one embodiment, a method herein comprises: receiving, by a first access point having a transmit opportunity for a wireless channel in a wireless network, information indicative of buffered traffic at two or more other access points operating on the wireless channel; determining, by the first access point, based on spatial isolation information, that the two or more other access points are compatible for concurrent transmissions during a portion of the transmit opportunity; selecting, by the first access point, a coordinated spatial reuse configuration in which the two or more other access points are permitted to communicate concurrently during the portion of the transmit opportunity while the first access point refrains from transmitting user data during the portion; and transmitting, by the first access point, control signaling that causes the two or more other access points to perform the concurrent transmissions during the portion of the transmit opportunity.

### RELATED APPLICATION

This application claims priority to U.S. Provisional Patent Appl Ser. No. 63/761,306, filed on Feb. 21, 2025, entitled “MODES FOR COORDINATED SPATIAL REUSE WITHOUT THE TXOP-HOLDING AP” by Brian Hart, et al., the contents of which are incorporated by reference herein.

### TECHNICAL FIELD

The present disclosure relates to wireless networking, and, more particularly, to coordinated spatial reuse using transmit opportunity (TXOP) portion allocation by a TXOP-holding access point (AP).

### BACKGROUND

In wireless networks, wireless transmissions/signals can propagate beyond their intended recipients and cause interference to other communication links. Various mitigations are provided for that at the Media Access Control (MAC) and/or Physical (PHY) layer. IEEE 802.11 wireless networks use Carrier Sense Multiple Access/Collision Avoidance (CSMA/CA) in general to address this problem, but extensions towards greater determinism for Augmented Reality/Virtual Reality/Mixed Reality (AR/VR/MR) and automated manufacturing are sought. Within a Basic Service Set (BSS), there is triggered access and/or Restricted Target Wake Time (R-TWT) which provide a high degree of intra-BSS determinism, but there is presently no coordination between co-channel BSSs, which completely undermines any guarantees sought by triggered access and/or R-TWT. The 802.11ax amendment introduced various types of Spatial Reuse but these are uncoordinated between BSSs and do not solve the problem well.

Accordingly, the 802.11bn amendment effort is considering Multi-AP Coordination (MAPC), with variations from simpler (Coordinated R-TWT (Co-RTWT), Coordinated Time Division Multiple Access (Co-TDMA)) to moderately more complex (Coordinated Spatial Reuse (Co-SR), Coordinated Beamforming (Co-BF) with nullsteering-both related to a transmit opportunity (TXOP) holding AP and a second AP), to the more complicated (Coordinated-Orthogonal Frequency Division Multiple Access (Co-OFDMA), Joint Transmission (JT), and Joint Reception (JR) schemes although this latter group are basically not viable options in this generation.

Co-SR is reasonably implementable, but IEEE 802.11bn is currently focused on a TXOP holding AP and a second AP. These are typically closer, with worse Signal-to-Interference Ratios and thus lower Modulation and Coding Schemes (MCSs). A better/complementary scheme is for a TXOP-holding AP to share with two (or more) other APs (e.g., one on the left and one on the right) given that they will often have better isolation.

The protocol to enable this, leveraging existing IEEE 802.11bn Co-SR work to achieve greater simplicity, has not been heretofore defined.

### BRIEF DESCRIPTION OF THE DRAWINGS

The detailed description is set forth below with reference to the accompanying figures. The use of the same reference numbers in different figures indicates similar or identical items. The systems depicted in the accompanying figures are not to scale and components within the figures may be depicted not to scale with each other.

FIGS. 1A-1D are diagrams showing types of Coordinated Spatial Reuse (Co-SR) that involve a transmit opportunity (TXOP)-holding access point (AP), and upon which improvements can be achieved using techniques presented herein.

FIG. 2 illustrates conventional techniques that do not adequately address the case of two well-separated Overlapping Basic Service Set (OBSS) APs reporting they have high priority, about-to-expire traffic.

FIGS. 3A-3C illustrate techniques by which the AP that transmits a co-trigger frame is changed to be the TXOP-holding non-Co-SR-participating AP, according to example embodiments.

FIGS. 4A-4C illustrate techniques by which an additional preceding trigger frame is sent by a sharing AP, according to example embodiments.

FIG. 5 illustrates an example high-level operational flow for implementing coordinated spatial reuse scheduling in which a TXOP-holding access point allocates a portion of the TXOP to two or more other access points for concurrent transmission/reception, according to an example embodiment.

FIG. 6 illustrates an example simplified procedure for coordinated spatial reuse using TXOP allocation by a TXOP-holding AP in accordance with one or more embodiments described herein.

FIG. 7 is a hardware block diagram of device configured to perform functions associated with operations discussed in connection with embodiments herein.

### DETAILED DESCRIPTION

### Overview

Coordinated Spatial Reuse (Co-SR) as currently defined does not provide for a high-efficiency/high-Quality of Service (QoS) mode. The sharing access point (AP) must transmit within its BSS at the same time as the coordinated AP is transmitting within its BSS. Both APs are typically closer and thus operate at a relatively low Signal-to-Interference-plus-Noise Ratio (SINR) and Modulation and Coding Scheme (MCS). A high efficiency+high QoS mode, as presented herein, allows an AP to share a portion of its transmit opportunity (TXOP). With APs having greater spatial separation (e.g., to left and right of TXOP-holding AP), mutually high MCSs are achievable within both Overlapping Basic Service Sets (OBSSs). For the APs with the traffic that is highest priority and closest to expiry, this efficiency and high QoS can be achieved even if that does not include the TXOP-holding AP.

In certain embodiments, the TXOP-holding access point allocates a portion of its TXOP exclusively to coordinated access points and refrains from transmitting user data during the allocated portion(s) of the coordinated spatial reuse interval.

Techniques are presented herein to use MCSs, nearby BSS load and/or urgency to decide which APs to transmit sooner (i.e., better efficiency and quality of service (QoS)) via modification of a (in Class B) or add a (in Class C) Trigger frame at the beginning of the Co-SR allocation of a portion of the TXOP so that two or more APs, not including the TXOP holder, can transmit in parallel.

In various embodiments, selection of coordinated access points and allocation of TXOP duration are determined using one or more scheduling algorithms that consider modulation and coding scheme viability (e.g., though APs mostly support high MCSs, difficulty arises when they are close enough that high MCSs aren't viable due to interference), buffered traffic priority, buffered traffic urgency (i.e., imminence of latency deadlines), and spatial reuse compatibility (e.g., having traffic of similar durations and/or expanding MCS viability to NSS viability, too).

In one specific embodiment, a method herein may comprise: receiving, by a first access point having a transmit opportunity for a wireless channel in a wireless network, information indicative of buffered traffic at two or more other access points operating on the wireless channel; determining, by the first access point, based on spatial isolation information, that the two or more other access points are compatible for concurrent transmissions/receptions during a portion of the transmit opportunity; selecting, by the first access point, a coordinated spatial reuse configuration in which the two or more other access points are permitted to communicate concurrently during the portion of the transmit opportunity while the first access point refrains from transmitting user data during the portion; and transmitting, by the first access point, control signaling that causes the two or more other access points to perform the concurrent transmissions/receptions during the portion of the transmit opportunity.

Other implementations are described below, and this overview is not meant to limit the scope of the present disclosure.

### EXAMPLE EMBODIMENTS

In a wireless local area network (WLAN) or Wi-Fi® network, one or more wireless APs provide wireless Radio Frequency (RF) coverage over which one or more wireless devices (e.g., laptops, phones, wearable devices, tablets, etc.) can connect to the APs in order to connect to one or more data networks (e.g., the public Internet, an enterprise network operated by an enterprise entity (e.g., a business, institution, university, etc.)), and/or the like.

As described above, Co-SR as currently defined does not provide for a high-efficiency/high-QoS mode. The sharing AP needs to transmit within its BSS at the same time as the coordinated AP is transmitting within its BSS. Both APs typically operate at a relatively low Signal-to-Interference-plus-Noise Ratio (SINR) and so a lower Modulation and Coding Scheme (MCS) (including a lower number of spatial streams).

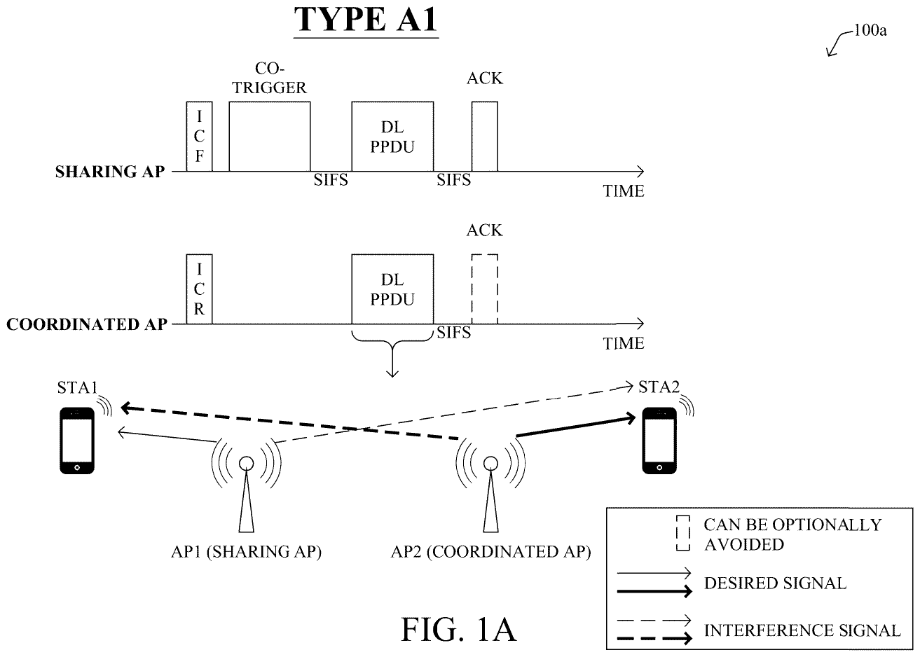

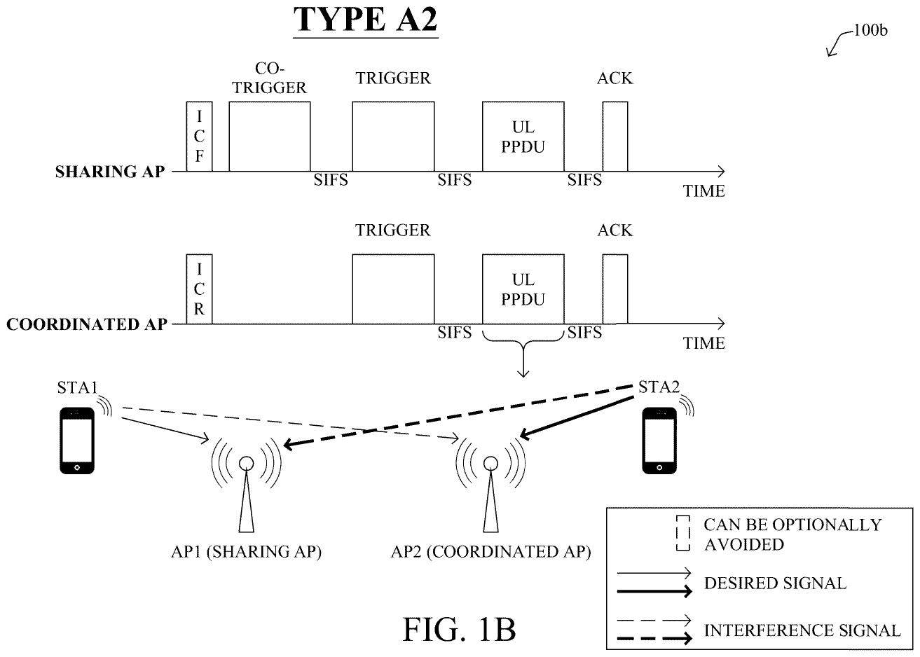

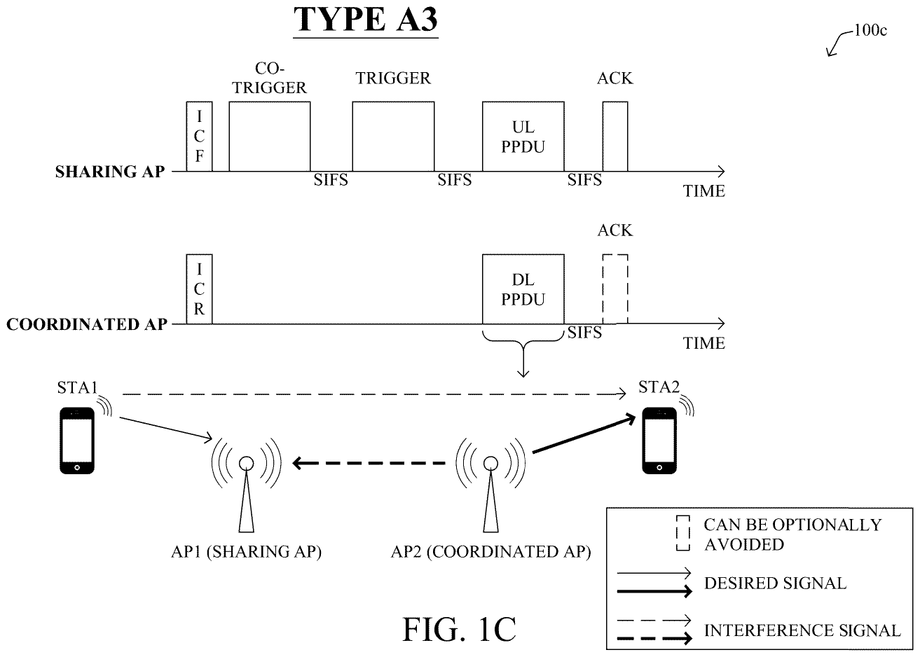

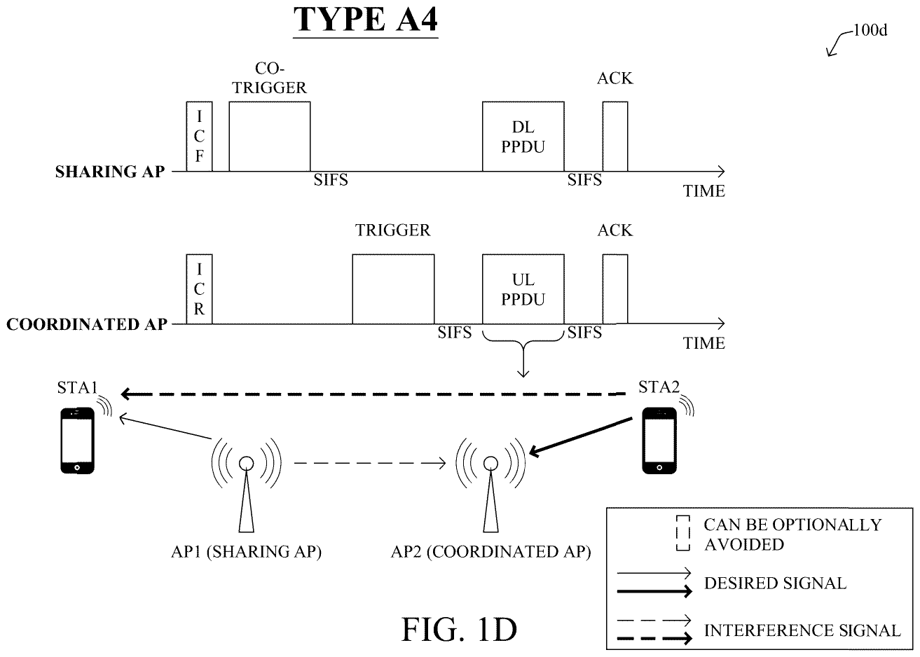

FIGS. 1A-1D illustrate example baseline Coordinated Spatial Reuse (Co-SR) transmission patterns 100a-d involving a transmit-opportunity (TXOP) holding access point and a coordinated access point, prior to the enhancements described in this disclosure. For clarity, FIGS. 1A-1D are labeled as Types A1-A4, respectively, and collectively demonstrate variations of existing Co-SR behavior in which coordination occurs between a sharing access point and a single coordinated access point during a TXOP.

In each of FIGS. 1A-1D, a first access point AP1 operates as a sharing access point that has obtained a TXOP through contention-based medium access. A second access point AP2 operates as a coordinated access point belonging to an overlapping basic service set (OBSS). AP1 and AP2 each serve one or more associated stations (STA1, STA2), and the figures illustrate example downlink (DL) and uplink (UL) PHY protocol data unit (PPDU) exchanges between the access points and their respective stations during the TXOP.

Coordination between AP1 and AP2 is initiated using control signaling, including an initial control frame (ICF), an initial control response (ICR) frame, and a coordinated trigger (Co-Trigger) frame. These control frames are exchanged with short interframe spacing (SIFS) intervals, as illustrated, to establish timing and permissions for coordinated transmissions. In each case, AP1 transmits the Co-Trigger frame and participates directly in the coordinated spatial reuse by transmitting user data during the TXOP concurrently with transmissions by AP2.

Across all four types, the desired signal paths and interference signal paths are illustrated to highlight where simultaneous transmissions may introduce interference, and where such interference may optionally be avoided depending on timing and direction of transmission. As shown, these baseline Co-SR modes rely on coordination between AP1 and AP2, which are typically in relatively close proximity, often resulting in lower signal-to-interference ratios and reduced modulation and coding schemes.

FIG. 1A, specifically, illustrates a first baseline Co-SR mode (Type A1) in which AP1 and AP2 perform coordinated downlink transmissions to their respective stations during overlapping portions of the TXOP. AP1 transmits a Co-Trigger frame to AP2, after which both access points transmit DL PPDUs to their associated stations. Acknowledgments (labelled ACK, which covers both Ack and BA frames) are exchanged following the DL transmissions. In this configuration, both access points transmit user data concurrently, and interference between the transmissions may occur depending on spatial separation and channel conditions.

FIG. 1B illustrates a variation (Type A2) in which coordinated uplink transmissions are performed instead of, or in addition to, downlink transmissions. After transmission of the Co-Trigger frame by AP1, stations associated with AP1 and AP2 transmit uplink PPDUs to their respective access points during overlapping portions of the TXOP. As with Type A1, AP1 participates directly in the coordinated spatial reuse and user data transmissions, and interference between uplink transmissions may occur depending on relative station locations and isolation.

FIG. 1C illustrates another baseline variation (Type A3) in which a mixture of downlink and uplink transmissions are coordinated during the TXOP. For example, AP1 may transmit a downlink PPDU to its associated station while a station associated with AP2 transmits an uplink PPDU to AP2. The Co-Trigger frame transmitted by AP1 defines the timing and permissions for these mixed-direction transmissions. Although this arrangement can reduce certain interference paths relative to Type A1 or A2, AP1 and AP2 still transmit user data during overlapping time intervals and remain constrained by their proximity and mutual interference.

FIG. 1D illustrates a further baseline variation (Type A4) in which the ordering or directionality of coordinated transmissions is adjusted to optionally avoid specific interference paths. In this example, certain desired signal paths are scheduled such that interference signals may be reduced or avoided for particular transmission directions. Nevertheless, AP1 continues to act as both the TXOP holder and a participating transmitter of user data, and coordination remains limited to a single coordinated access point. As a result, the achievable spatial reuse gains are constrained, particularly in dense deployments where multiple OBSS access points may have high-priority traffic.

As illustrated by FIGS. 1A-1D, baseline Co-SR techniques require the TXOP-holding access point to participate directly in user data transmission during the coordinated interval and are limited to coordination with a single other access point. These constraints motivate the enhanced techniques described elsewhere in this disclosure, which enable the TXOP-holding access point to allocate a portion of the TXOP to multiple other access points for concurrent transmission/reception, including embodiments in which the TXOP-holding access point does not transmit user data during the coordinated spatial reuse interval.

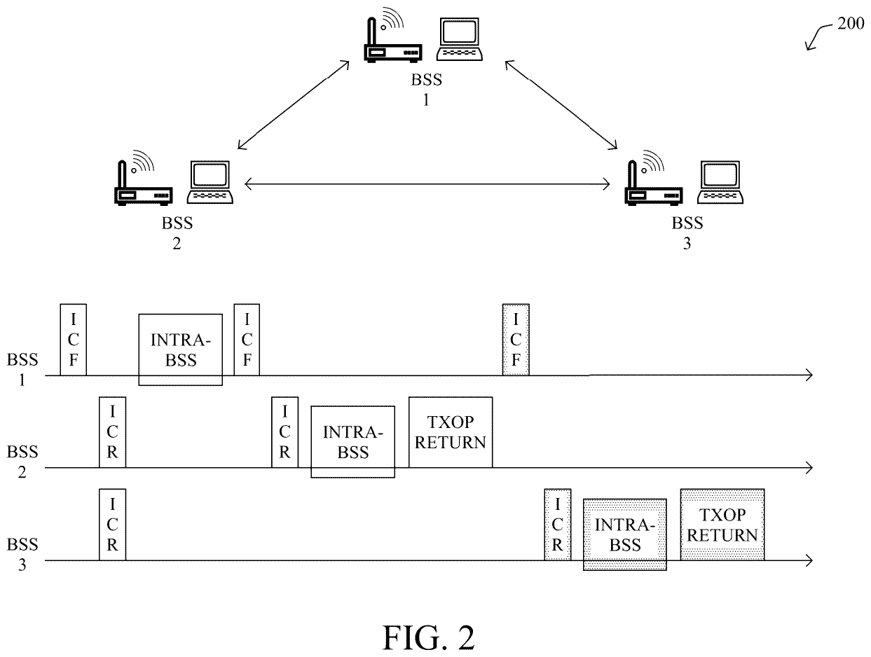

Reference is now made to FIG. 2. None of types A1-A4 address the case of two well-separated OBSS APs reporting they have high priority and/or about-to-expire traffic. Throughput stability can be improved when the destination station (STA)/client of Co-SR is a high SIR STA.

Consider the case of:
AP1's BSS has moderate-priority, moderate expiry-imminence buffered traffic.
AP1 contends and wins.
AP1 performs Multi-Access Point Coordination (MAPC) ICF+ICR, and learns BSSs 2 and 3 have higher-priority and/or earlier-expiry buffered traffic.
AP1 is aware of the relative isolation between BSS 2 and 3 or specific STAs within the BSSs (e.g., via over-the-wire signaling, also known as out-of-band signaling; but also the communication might be in-band (over the air).).

A current solution is to use Co-TDMA for BSS 2 then for BSS 3, but taking turns in this manner consumes more wireless resources than spatial reuse (as shown in the shaded boxes).

In greater detail, FIG. 2 illustrates a representative scenario 200 that highlights a limitation of baseline coordinated access techniques when multiple overlapping basic service sets (OBSSs) concurrently require medium access. In the example of FIG. 2, three access points operate on the same channel: a first access point (BSS1) that obtains a transmit opportunity (TXOP), and two neighboring access points (BSS2 and BSS3) that each have buffered traffic with high priority and/or traffic nearing expiration.

As shown, the TXOP-holding access point associated with BSS1 initiates a coordination exchange, for example using an initial control frame (ICF) and receiving corresponding initial control response frames (ICRs) from the access points associated with BSS2 and BSS3. Through this exchange, the TXOP-holding access point learns that both BSS2 and BSS3 require medium time. The TXOP-holding access point may further be aware, for example through prior measurements or out-of-band signaling, that BSS2 and BSS3 (or specific STAs within the BSSs) are relatively well isolated from one another.

Despite this knowledge, baseline coordination techniques typically allocate the TXOP sequentially rather than concurrently. As illustrated, the TXOP is returned or divided such that BSS2 and BSS3 transmit in separate, non-overlapping time intervals, for example using coordinated time-division multiple access (Co-TDMA). While this approach avoids interference, it consumes more wireless resources and increases latency, particularly when both BSS2 and BSS3 have urgent traffic.

FIG. 2 thus illustrates the inefficiency that arises when multiple OBSS access points with high-priority traffic cannot be scheduled concurrently, even when spatial isolation would permit simultaneous transmissions.

According to the techniques herein, however, a high efficiency and high QoS mode allows an AP to share a portion of its TXOP. With APs having greater spatial separation (e.g., to left and right of TXOP-holding AP), mutually high MCSs are achievable within both Overlapping BSS's (OBSSs). For the APs with the traffic that is highest priority and closest to expiration, this applies even if that does not include the TXOP-holding AP. This requires the TXOP-holding AP to behave selflessly, and so it is a technique better suited to APs within the same administrative domain (e.g., same ESS) that are so configured. Synergistically, APs within the same administrative domain are more likely to have (low latency) out of band (over the wire) connectivity among themselves.

Two enhanced C-SR classes are possible:
//Class A-Status quo (solution shown in FIGS. 1A-1D)
Class B-Existing Co-SR Trigger frame evolves to support non-Co-SR participating Sharing AP, or
Class C-Additional Trigger frame ahead of the existing Co-SR Trigger frames.

Although example embodiments describe two coordinated access points, the techniques herein extend to three or more coordinated access points selected based on mutual spatial isolation and scheduling constraints. Also, as described below, in certain embodiments, the TXOP-holding access point may allocate a portion of its TXOP exclusively to coordinated access points and, if so, refrains from transmitting user data during the coordinated spatial reuse interval.
Class B: With respect to Class A, change transmitter of Co-Trigger frame

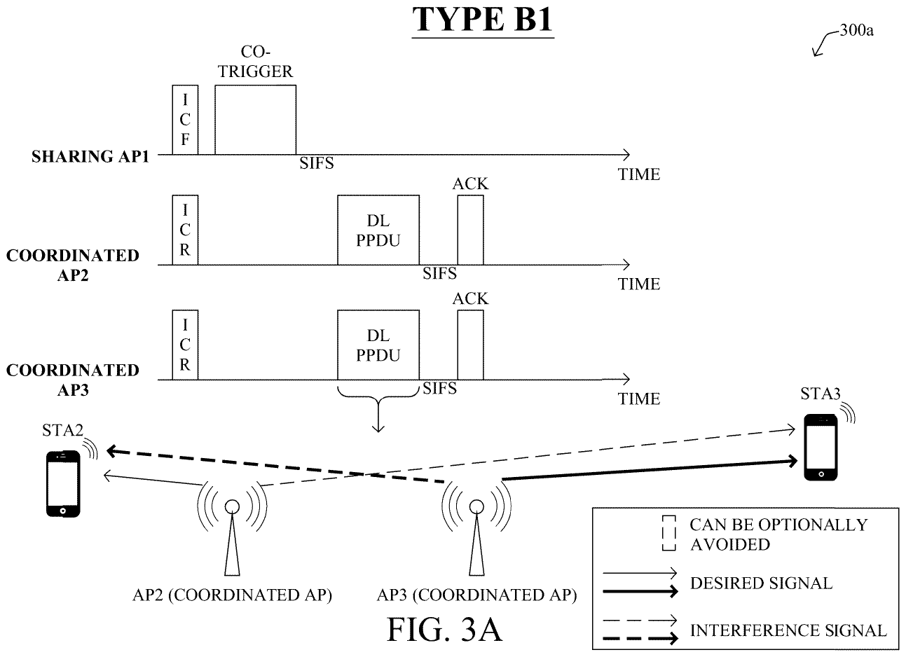

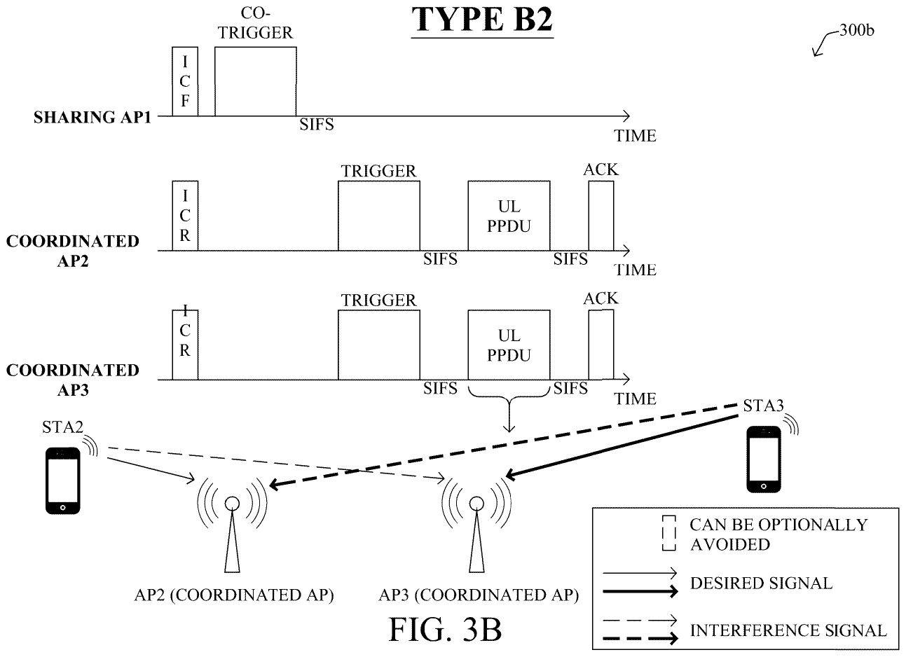

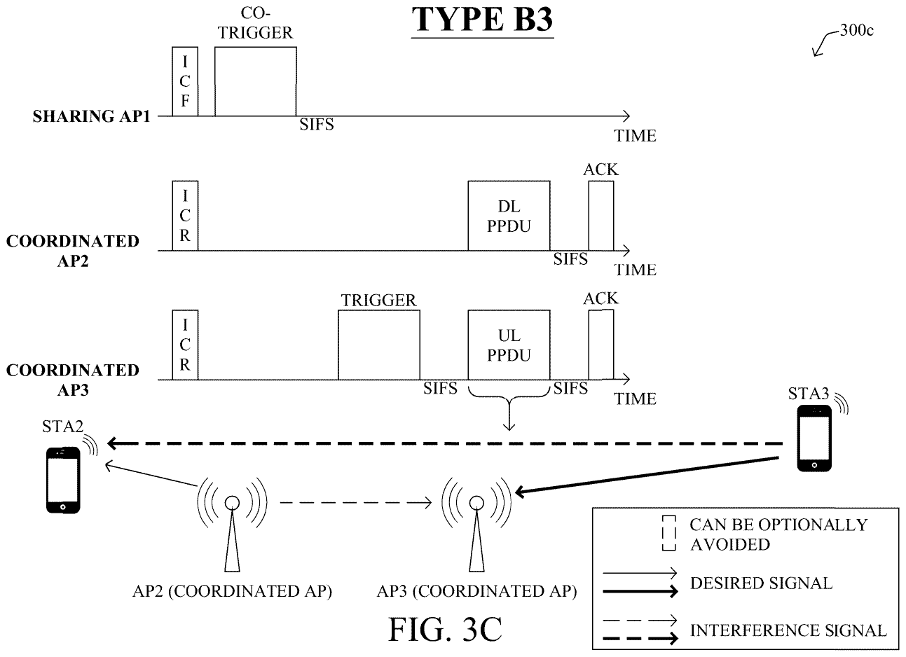

Reference is now made to FIGS. 3A-3C. These variants 300a-c are referred to as Class B, leading to types B1-B3 (B3 evolves both A3 and A4). The Co-Trigger frame sent by the TXOP-holding Co-SR-participating AP evolves to a Co-Trigger frame sent by the TXOP-holding non-Co-SR-participating AP1. There is no requirement that Coordinated APs AP2 and AP3 can even hear each other. (Not shown in FIGS. 3A-3C are inter-BSS pathloss measurement taking and reporting.)

In particular, FIGS. 3A-3C illustrate example embodiments of a first enhanced coordinated spatial reuse class, referred to herein as Class B, corresponding to Types B1-B3, respectively. These embodiments extend baseline coordinated spatial reuse by modifying the role of the TXOP-holding access point with respect to trigger transmission, while enabling concurrent transmissions/receptions by multiple coordinated access points.

In each of FIGS. 3A-3C, a first access point (AP1) obtains a TXOP and acts as a sharing access point for purposes of coordination. Two (or more, in some embodiments) other access points (AP2 and AP3), associated with overlapping basic service sets, have buffered traffic that is high(er) priority and/or close(r) to expiration. AP1 has knowledge, for example via prior measurements or out-of-band signaling, that AP2 and AP3 (and considering specific or all of their associated clients too) are sufficiently spatially isolated to permit concurrent transmissions/receptions.

Unlike the baseline arrangements shown in FIGS. 1A-1D, AP1 in the Class B embodiments does not participate directly in spatial reuse transmissions during the coordinated interval. Instead, AP1 transmits a coordinated trigger frame that authorizes and coordinates AP2 and AP3 to communicate concurrently during a portion of AP1's TXOP. Notably, AP2 and AP3 are not required to detect or decode one another's transmissions, and coordination is orchestrated entirely by AP1.

FIG. 3A illustrates a first Class B variant 300a (Type B1) in which AP1 transmits a coordinated trigger frame that enables AP2 and AP3 to perform concurrent downlink transmissions to their respective associated stations. Following the trigger, AP2 and AP3 transmit downlink PPDUs during overlapping time intervals, and acknowledgments are returned by the stations. AP1 refrains from transmitting user data during the coordinated spatial reuse interval.

FIG. 3B illustrates a second Class B variant 300b (Type B2) in which AP1 authorizes coordinated uplink transmissions. In this embodiment, following transmission of the coordinated trigger frame by AP1, then trigger frames by AP2 and AP3, stations associated with AP2 and AP3 transmit uplink PPDUs concurrently to their respective access points. AP1 again does not participate in user data transmission during the coordinated interval, and AP2 and AP3 operate concurrently without requiring inter-AP awareness.

FIG. 3C illustrates a third Class B variant 300c (Type B3) that supports mixed-direction coordinated transmissions. In this embodiment, one of AP2 or AP3 may perform a downlink transmission while the other performs an uplink transmission during the same coordinated interval, as authorized and coordinated by the trigger transmitted by AP1. This arrangement allows additional flexibility in scheduling based on traffic direction, urgency, and channel conditions, while preserving the advantages of concurrent spatial reuse enabled by AP1's coordination.
Class C: With respect to Class A, send extra Trigger frame, for encapsulated Co-SR

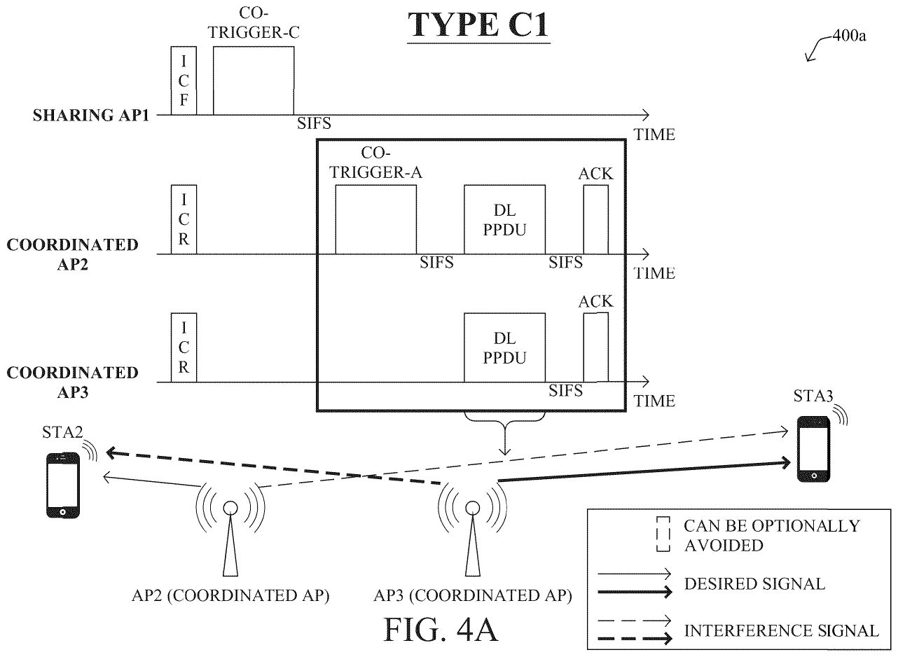

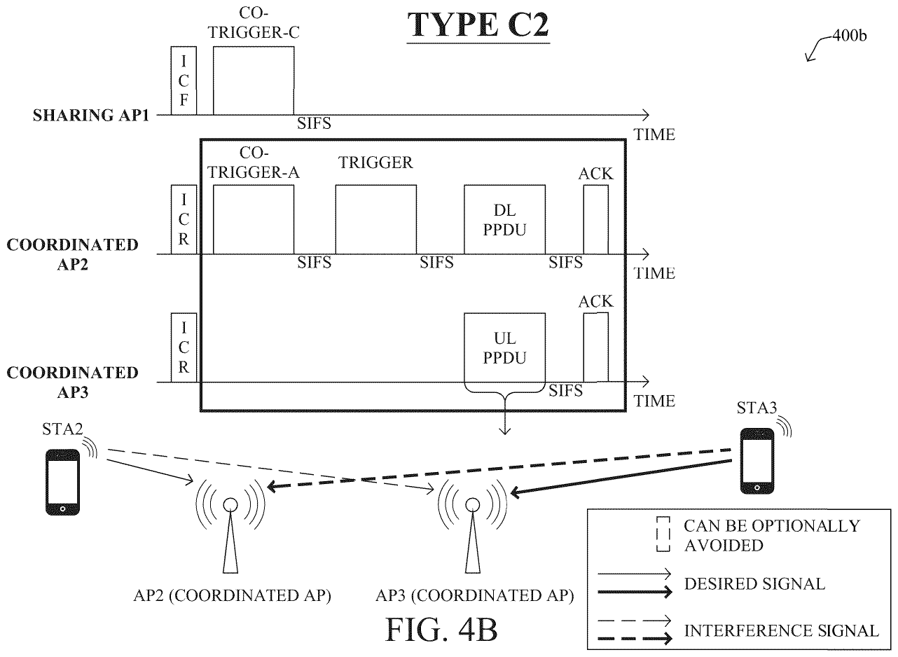

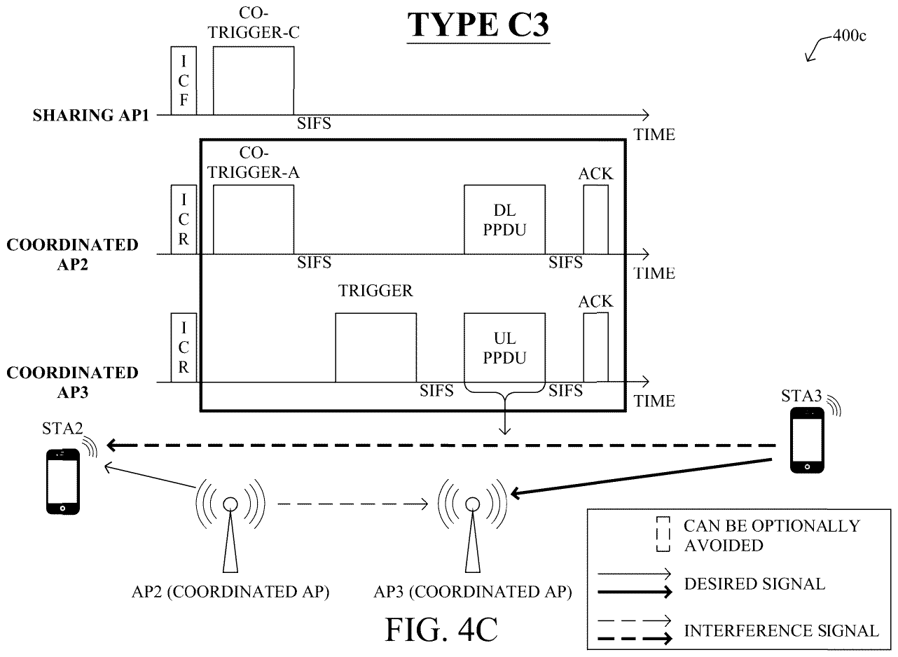

Reference is now made to FIGS. 4A-4C. These variants 400a-c are referred to as Class C, leading to types C1-C3 (C3 evolves A3 and A4). Types C1/C2/C3 are the same as types A1/A2/A3+A4 but with an extra preceding Trigger (Co-Trigger-C) sent by the Sharing AP. Everything after that is the same as types A1/A2/A3+A4 (see encapsulated contents of rounded rectangle) in the figure. (Not shown in FIGS. 4A-4C are inter-BSS pathloss measurement and reporting.)

In particular, FIGS. 4A-4C illustrate example embodiments of a second enhanced coordinated spatial reuse class, referred to herein as Class C, corresponding to Types C1-C3, respectively. The Class C embodiments build upon baseline coordinated spatial reuse by introducing an additional trigger frame that precedes existing coordinated trigger signaling, enabling encapsulated or staged coordination of multiple access points.

In each of FIGS. 4A-4C, a first access point (AP1) obtains a TXOP and acts as the coordinating entity. AP1 identifies two (or more, in some embodiments) other access points (AP2 and AP3) that have buffered traffic requiring medium time and that are compatible for concurrent transmissions/receptions based on spatial isolation information. As in the Class B embodiments, AP1 may refrain from transmitting user data during the coordinated spatial reuse interval.

In the Class C embodiments, AP1 transmits an additional preceding trigger frame (referred to as Co-Trigger-C) that identifies the coordinated access points and/or compatible stations prior to the transmission of a baseline coordinated trigger. This approach allows existing coordinated spatial reuse procedures to be reused following the initial setup, while extending coordination to multiple access points.

FIG. 4A illustrates a first Class C variant 400a (Type C1) in which AP1 transmits a Co-Trigger-C frame that establishes the coordinated spatial reuse context for AP2 and AP3. Following this preceding trigger, coordinated downlink transmissions are performed by AP2 and AP3 during overlapping portions of the TXOP, in accordance with subsequent trigger signaling. AP1 does not transmit user data during the coordinated interval.

FIG. 4B illustrates a second Class C variant 400b (Type C2) in which the preceding Co-Trigger-C frame enables coordinated uplink transmissions. Stations associated with AP2 and AP3 transmit uplink PPDUs concurrently following the trigger sequence, allowing high(er) priority and/or (more) urgent uplink traffic to be serviced efficiently while leveraging spatial isolation between the access points (and specific or all of their associated STAs).

FIG. 4C illustrates a third Class C variant 400c (Type C3) that supports mixed-direction coordinated transmissions, similar to Type B3. In this embodiment, the preceding Co-Trigger-C frame establishes coordination for AP2 and AP3, after which one access point may perform a downlink transmission while the other supports an uplink transmission during the same coordinated interval. This embodiment demonstrates that the encapsulated trigger approach of Class C can support a wide range of coordinated spatial reuse patterns while maintaining compatibility with existing coordinated trigger mechanisms.
High-level procedure

Assume baseline downlink (DL) Co-SR is:
Intermittent measurement by pairs of APs to measure the relative DL Signal-to-Interference Ratio (SIR) isolation between “i.” all, or “ii.” specific non-AP STAs in their BSSs; and they determine the mutual DL SIR isolation to be high.
At start of a TXOP, use Initial Control Response (ICR)+Initial Control Response (ICR) Frames to learn required medium time. For ii., also report which specific Co-SR-measured non-AP STA(s) in the BSS need (most of) that medium time.
Perform Co-SR if advised. For ii., this involves selecting specific compatible Co-SR-measured non-AP STA(s) in the BSS, and listing the specific STA(s) of the OBSS in the Co-SR trigger frame; TX power+MCS (optionally including number of spatial streams NSS too) are also specified as needed.

With Class B/C Co-Sr:
APs B and C negotiate support for (Class C) Co-SR with AP A.
Using the usual Co-SR techniques, APs B and C measure the relative SIR isolation between their BSSs and/or specific non-AP STAs in their BSSs, and, where they determine the isolation to be high, report the conditions to nearby APs, such as AP A, as needed (regularly/upon a change). Useful higher system gains come when these reports are sent out-of-band. This may limit usage of this Co-SR variant to APs in the same administrative domain. In some embodiments, reports of spatial isolation are exchanged out-of-band, including over wired backhaul or controller-mediated signaling, enabling higher system gains without requiring over-the-air coordination.
Class B: AP A learns the need for medium time at BSSs B and C via ICF+ICR, so has equivalent information as APs B/C, and so triggers Co-SR directly. For ii., again, specific STA(s) are listed in the ICRs, then specific compatible STA(s) for each AP are listed in the Co-Trigger frame.
Class C: Similar to Class B, except for ii., the specific compatible STA(s) for both APs are listed in the new Co-Trigger-C frame to one AP.

In summary, Co-SR as currently defined does not provide for a high-efficiency/high-QoS mode. The sharing AP must transmit within its BSS at the same time as the coordinated AP is transmitting within its BSS. Both APs typically operate at a relatively low SINR and MCS.

On the other hand, a high efficiency+high QoS mode, as presented herein, allows an AP to share a portion of its TXOP. With APs having greater spatial separation (e.g., to left and right of TXOP-holding AP), mutually high MCSs are achievable within both OBSSs. For the APs with the traffic that is highest priority and closest to expiry, this efficiency and high QoS can be achieved even if that does not include the TXOP-holding AP.

Two enhanced C-SR classes are possible:
Class B-Existing Co-SR Trigger frame evolves to support non-Co-SR participating Sharing AP.
Class C-Additional Trigger frame ahead of the existing Co-SR Trigger frames.

Enterprise networks can be deployed such that there is an expectation of appreciable throughput and/or latency gains with Coordinated Spatial Reuse (Co-SR) that supports 2+ APs to be joint simultaneously scheduled as per the techniques presented herein. These techniques could use MCSs, nearby BSS load, priority and/or urgency to decide which APs to transmit sooner (i.e., better efficiency and QoS) via modification of a (in Class B) or add the (in Class C) Trigger frame at the beginning of the Co-SR allocation of a portion of the TXOP so that two APs, not including the TXOP holder, can transmit in parallel.

Consider, for example, an enterprise wireless deployment in which three access points operate on the same channel. A first access point obtains a TXOP through contention but has only moderate-priority buffered traffic. Two neighboring access points, located on opposite sides of the first access point, each have latency-critical traffic nearing expiration. Based on previously exchanged spatial isolation measurements, the first access point determines that the two neighboring access points can communicate concurrently (e.g., transmit and/or receive) with minimal mutual interference. The first access point therefore allocates a portion of its TXOP to the two neighboring access points and transmits control signaling identifying the permitted stations, transmission parameters, and timing. During the allocated portion, the two neighboring access points transmit simultaneously at high modulation and coding schemes, completing their urgent transmissions without interference and without requiring the first access point to transmit data.

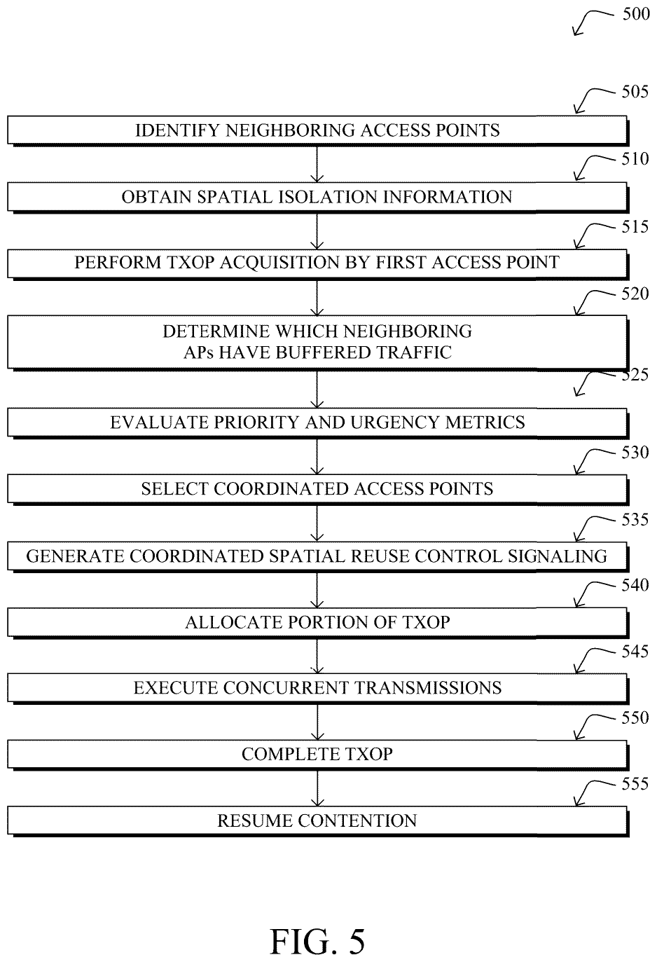

FIG. 5 describes an example high-level operational flow 500 for implementing coordinated spatial reuse scheduling in which a TXOP-holding access point allocates a portion of the TXOP to two or more other access points for concurrent transmission/reception, including embodiments consistent with the Class B and Class C techniques described above (e.g., the modified transmitter of the Co-Trigger frame and/or the additional preceding Co-Trigger-C frame). In this flow, the network leverages information such as buffered traffic priority, buffered traffic urgency, required medium time, and spatial isolation (for example, SIR/pathloss measurements and reporting, including optional out-of-band reporting) to determine when two spatially separated overlapping BSSs can transmit in parallel at high MCS without requiring the TXOP-holding access point to transmit data during the coordinated interval.

In step 505, a first access point identifies neighboring access points (APs). Then, in step 510, the first access point obtains or accesses information indicative of spatial isolation between candidate coordinated access points and/or between specific non-AP stations in the respective BSSs. In some embodiments, this information is derived from intermittent inter-BSS measurements performed by pairs of access points to determine relative downlink SIR isolation between (i) the BSSs as a whole, and/or (ii) specific non-AP stations in each BSS. In certain deployments, access points exchange these measurement results and associated conditions out-of-band (for example, over a wired backhaul or controller-mediated signaling), which can provide higher system gains and reduce the need for over-the-air coordination signaling overhead.

In step 515, the first access point obtains a transmit opportunity (TXOP) for the shared channel. For example, the first access point (AP1) contends for the medium and wins, thereby becoming the TXOP-holding access point for the TXOP interval. In various embodiments, AP1 may have buffered traffic of its own (for example, moderate priority and moderate expiry imminence), but the techniques herein do not require that AP1 be the access point that transmits during the coordinated spatial reuse portion of the TXOP.

In step 520, the TXOP-holding access point initiates a coordination exchange to determine whether neighboring APs (overlapping BSSs) have buffered traffic that would benefit from receiving medium time during the current TXOP. In one example, AP1 performs a Multi-AP Coordination (MAPC) exchange using an initial control frame/response procedure (e.g., ICF/ICR) and thereby receives control response information (ICRs) from one or more neighboring access points (e.g., AP2 and AP3). The ICRs may indicate required medium time, and may further identify traffic priority and/or urgency, such as traffic that is high-priority (such as voice) and/or close to expiry.

In step 525, the TXOP-holding access point evaluates scheduling criteria to determine whether coordinated spatial reuse is advisable for the current TXOP, and selects candidate coordinated access points and/or specific stations that are compatible for concurrent transmission/reception. In various embodiments, this evaluation considers one or more of: the priority or urgency (such as expiry imminence) indicated by the ICRs, the amount of required medium time, BSS load, and expected achievable MCS/SINR for candidate links given the spatial isolation information. In a representative scenario, AP1 determines that AP2 and AP3 have the higher/highest priority and/or earlier/earliest-expiry buffered traffic, and further determines that AP2 and AP3 are sufficiently spatially separated (for example, “left” and “right” of AP1) to support mutually high MCS transmissions when scheduled concurrently.

In step 530, the TXOP-holding access point selects a coordinated spatial reuse configuration that enables at least two coordinated access points to communicate concurrently during a portion of the TXOP, without requiring the TXOP-holding access point to transmit data during that coordinated interval. In some embodiments, AP1 selects a Class B technique in which the transmitter of a coordinated trigger is changed to the TXOP-holding access point even though that access point is non-participating with respect to the spatial reuse transmission itself. In other embodiments, AP1 selects a Class C technique in which an additional preceding trigger (e.g., Co-Trigger-C) is sent to encapsulate or set up the ensuing coordinated spatial reuse trigger exchange, while leveraging existing coordinated trigger structures thereafter. In other embodiments, the underlying protocol defines only a subset of the techniques beyond Class A (e.g., either Class B or Class C; e.g. ; only class B1) and this constrains the selection options available to AP1.

In step 535, the TXOP-holding access point generates coordinated spatial reuse control signaling that defines the concurrent portion of transmission opportunity for the coordinated access points. This control signaling may identify which access points (and/or which specific stations within the coordinated BSSs) are permitted to communicate concurrently, and may further specify transmission parameters such as transmit power and/or MCS. For embodiments that operate at the per-station granularity, the control signaling may list specific non-AP stations identified in ICRs as requiring most of the medium time, and may further select compatible station pairings across the overlapping BSSs to improve throughput stability (for example, prioritizing “high SIR” destination stations for the spatial reuse transmissions).

In step 540, the TXOP-holding access point transmits the coordinated spatial reuse control signaling in accordance with the selected configuration. In a Class B embodiment, AP1 transmits a coordinated trigger frame (Co-Trigger) that initiates the coordinated spatial reuse allocation for AP2 and AP3, even though AP1 may not be a coordinated transmitter during the spatial reuse portion of the TXOP. In a Class C embodiment, AP1 transmits a preceding Co-Trigger-C that identifies the coordinated access points and/or compatible stations, followed by subsequent coordinated trigger signaling consistent with the baseline coordinated spatial reuse procedures. In either case, the control signaling is structured such that AP2 and AP3 need not be able to hear each other, and the TXOP-holding access point can orchestrate concurrent transmissions/receptions based on its knowledge of isolation and traffic urgency.

In step 545, the coordinated access points perform the concurrent transmissions/receptions during the allocated portion of the TXOP based on the received control signaling. For example, AP2 and AP3 transmit simultaneously to their respective stations (downlink), and/or schedule uplink transmissions from their stations, using the specified parameters (e.g., transmit power and MCS). Because AP2 and AP3 are selected based on high spatial isolation, both coordinated links can operate at higher MCS and improved SINR relative to conventional Co-SR pairings, thereby improving throughput and latency performance for the highest-priority and closest-to-expiry traffic.

In step 550, the coordinated spatial reuse portion of the TXOP concludes, and the TXOP is completed. Notably, in step 550, “complete TXOP” may involve multiple iterations of steps 530-545 above, all within the same TXOP. In some embodiments, in step 555, AP1 may resume non-coordinated transmissions during the remaining TXOP time (if any), allocate further spatial reuse portions, or other portions for other MAPC schemes (such as Co-TDMA) or may simply relinquish the medium at the end of the coordinated spatial reuse portion. The network then continues with subsequent contention and/or coordinated procedures. Measurement and reporting of spatial isolation may continue intermittently and be refreshed as conditions change, enabling future TXOPs to dynamically select coordinated access points and compatible stations based on updated isolation, load, and urgency conditions.

Advantageously, the techniques described herein provide significant improvements over existing coordinated spatial reuse mechanisms. By enabling multiple spatially separated access points to communicate concurrently (e.g., transmit and/or receive) during a portion of a TXOP without requiring participation by the TXOP-holding access point, the techniques herein improve spectral efficiency while preserving quality-of-service guarantees. Higher modulation and coding schemes are achievable due to improved signal-to-interference ratios, resulting in increased throughput and reduced latency. The techniques herein further enable deterministic scheduling across overlapping basic service sets, improving performance for latency-sensitive applications such as AR/VR, industrial automation, and real-time control systems. Importantly, these gains are achieved with minimal protocol complexity by leveraging and extending existing coordinated spatial reuse signaling mechanisms.

That is, wireless networks are increasingly used for applications that cannot tolerate unpredictable delays. Today's coordinated spatial reuse techniques still force nearby access points to take turns, even when they could safely transmit at the same time. The techniques herein address this by letting a network temporarily “loan” airtime to the access points that need it most, even if the access point that “won” the airtime is not the one transmitting. The result is faster data delivery, better reliability, and much more efficient use of wireless spectrum, especially in dense enterprise networks.

Notably, in alternative embodiments, coordinated spatial reuse may be applied to uplink transmissions, downlink transmissions, or combinations thereof, and may be used in conjunction with restricted target wake time (R-TWT), triggered access, or other deterministic scheduling mechanisms. In some implementations, the coordinated access points are selected dynamically on a per-TXOP basis, while in others they are selected semi-persistently based on historical traffic patterns and spatial isolation measurements. The control signaling may be generated by a centralized controller, a distributed coordination function, or negotiated peer-to-peer among access points. Additionally, coordinated spatial reuse may be applied across different frequency channels, bandwidths, or PHY configurations, including future IEEE 802.11 amendments. The coordinated spatial reuse technique may be applied among classic infrastructure APs or a mix of intrastructure and peer-to-peer (P2P) APs (or similar entities such as are found in Wi-Fi Direct and Wi-Fi Aware).

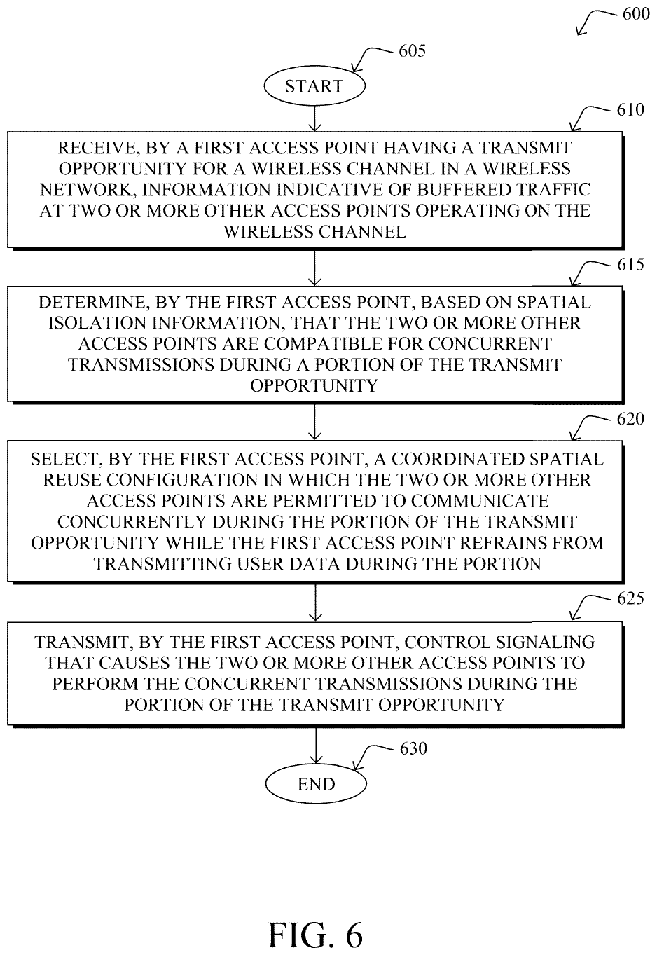

FIG. 6 illustrates an example simplified procedure for coordinated spatial reuse using TXOP allocation by a TXOP-holding AP in accordance with one or more embodiments described herein. For example, a non-generic, specifically configured device (e.g., an apparatus) may perform procedure 600 (e.g., a method) by executing stored instructions (e.g., a process). Procedure 600 may start at step 605 and continues to step 610, where, as described in greater detail above, a first access point (e.g., “sharing AP”) having a transmit opportunity (TXOP) for a wireless channel in a wireless network receives information indicative of buffered traffic at two or more other access points (e.g., “coordinated APs”) operating on the wireless channel. Optionally, this information may also identify specific stations associated with the two or more other access points.

In step 615, the first access point may then determine, based on spatial isolation information (e.g., received via out-of-band signaling in one embodiment), that the two or more other access points are compatible for concurrent transmissions/receptions during a portion of the transmit opportunity.

In step 620, the first access point selects a coordinated spatial reuse configuration in which the two or more other access points are permitted to communicate concurrently (e.g., transmit and/or receive) during the portion of the transmit opportunity while the first access point refrains from transmitting user data during the portion (e.g., based on at least one of traffic priority, urgency, buffer occupancy, pathloss isolation, achievable MCS (including NSS), or latency deadline). Note that in one embodiment, the coordinated spatial reuse configuration may be selected on a per-TXOP basis.

Then, in step 625, the first access point may transmit control signaling that causes the two or more other access points to perform the concurrent transmissions/receptions during the portion of the transmit opportunity. As described above, the control signaling may comprise a coordinated spatial reuse trigger frame, which may be preceded by a first trigger frame (e.g., that identifies the two or more other access points permitted to communicate concurrently). As noted, the control signaling may specify transmit power and/or a modulation and coding scheme for the concurrent transmissions/receptions, as well as specific stations permitted to participate in the concurrent transmissions/receptions. Notably, according to the techniques herein, the two or more other access points are not required to detect or decode transmissions from one another during this process.

The procedure may then end in step 630. Notably, the first access point need not (and illustratively does not) transmit user data during the portion of the transmit opportunity allocated to the concurrent transmissions.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative method herein may comprise: receiving, by a first access point having a transmit opportunity for a wireless channel in a wireless network, information indicative of buffered traffic at two or more other access points operating on the wireless channel; determining, by the first access point, based on spatial isolation information, that the two or more other access points are compatible for concurrent transmissions during a portion of the transmit opportunity; selecting, by the first access point, a coordinated spatial reuse configuration in which the two or more other access points are permitted to communicate concurrently during the portion of the transmit opportunity while the first access point refrains from transmitting user data during the portion; and transmitting, by the first access point, control signaling that causes the two or more other access points to perform the concurrent transmissions during the portion of the transmit opportunity.

In one embodiment, the control signaling comprises a coordinated spatial reuse trigger frame transmitted by the first access point.

In one embodiment, the control signaling comprises a first trigger frame transmitted prior to a coordinated spatial reuse trigger frame. In one embodiment, the first trigger frame identifies the two or more other access points permitted to communicate concurrently.

In one embodiment, the first access point does not transmit user data during the portion of the transmit opportunity allocated to the concurrent transmissions.

In one embodiment, the spatial isolation information is based on signal-to-interference ratio measurements between overlapping basic service sets.

In one embodiment, the spatial isolation information is received by the first access point via out-of-band signaling.

In one embodiment, the information indicative of buffered traffic identifies specific stations associated with the two or more other access points.

In one embodiment, the control signaling identifies specific stations permitted to participate in the concurrent transmissions.

In one embodiment, selecting the coordinated spatial reuse configuration is based on at least one of traffic priority, urgency, buffer occupancy, pathloss isolation, achievable MCS (including NSS), or latency deadline.

In one embodiment, the control signaling specifies at least one of a transmit power or a modulation and coding scheme for the concurrent transmissions.

In one embodiment, the two or more other access points are not required to detect or decode transmissions from one another.

In one embodiment, the coordinated spatial reuse configuration is selected on a per-transmit-opportunity basis.

In still other implementations, an illustrative apparatus herein may comprise: one or more network interfaces to communicate with a wireless network; a processor coupled to the one or more network interfaces and configured to execute one or more processes; and a memory configured to store a process that is executable by the processor, the process comprising: receiving, as a first access point having a transmit opportunity for a wireless channel in the wireless network, information indicative of buffered traffic at two or more other access points operating on the wireless channel; determining, based on spatial isolation information, that the two or more other access points are compatible for concurrent transmissions during a portion of the transmit opportunity; selecting a coordinated spatial reuse configuration in which the two or more other access points are permitted to communicate concurrently during the portion of the transmit opportunity while the first access point refrains from transmitting user data during the portion; and transmitting control signaling that causes the two or more other access points to perform the concurrent transmissions during the portion of the transmit opportunity.

In still other implementations, a tangible, non-transitory computer-readable medium may store computer-executable instructions that, when executed by one or more processors, cause a device to perform operations comprising: receiving, as a first access point having a transmit opportunity for a wireless channel in a wireless network, information indicative of buffered traffic at two or more other access points operating on the wireless channel; determining, based on spatial isolation information, that the two or more other access points are compatible for concurrent transmissions during a portion of the transmit opportunity; selecting a coordinated spatial reuse configuration in which the two or more other access points are permitted to communicate concurrently during the portion of the transmit opportunity while the first access point refrains from transmitting user data during the portion; and transmitting control signaling that causes the two or more other access points to perform the concurrent transmissions during the portion of the transmit opportunity.

Illustratively, the techniques described herein may be performed by hardware, software, and/or firmware, (e.g., an “apparatus”) such as in accordance with a spatial reuse process (e.g., a “method”), which may include computer-executable instructions executed by processor(s) to perform functions relating to the techniques described herein, e.g., in conjunction with corresponding processes of other devices in the computer network as described herein (e.g., on computing devices, servers, controllers, APs, etc.). In addition, the components herein may be implemented on a singular device or in a distributed manner, in which case the combination of executing devices can be viewed as their own singular “device” for purposes of executing the process(es).

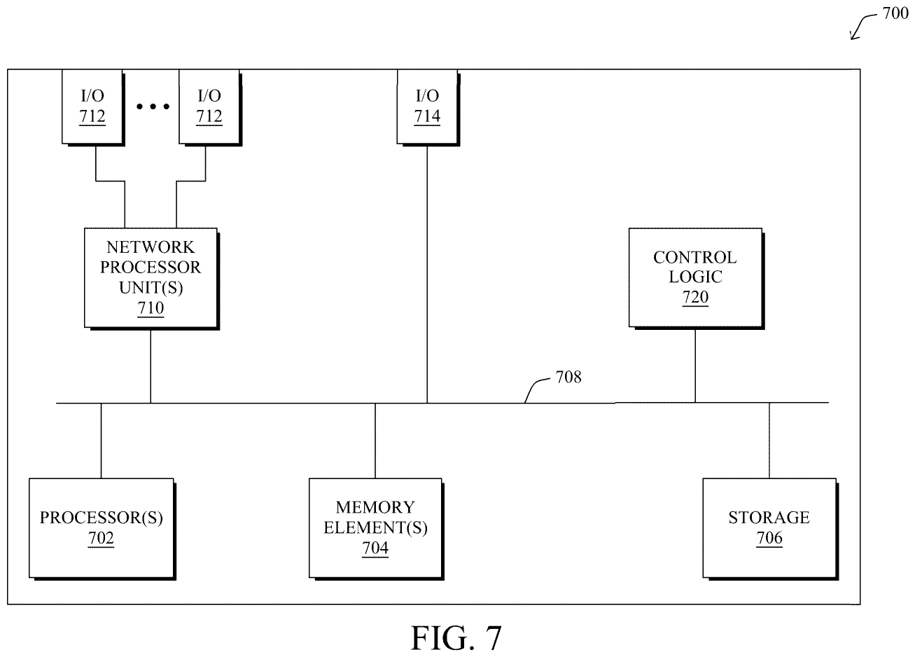

Referring to FIG. 7, FIG. 7 illustrates a hardware block diagram of a device 700 that may perform functions associated with operations discussed herein in connection with the techniques presented herein. In various embodiments, a computing device or apparatus, such as device 700 or any combination of devices like device 700, may be configured as any entity/entities as discussed for the techniques depicted presented herein in order to perform operations of the various techniques discussed herein. The device 700 may represent a wireless client device, an AP or a wireless network controller.

In at least one embodiment, the device 700 may be any apparatus that may include one or more processor(s) 702, one or more of memory element(s) 704, storage 706, a bus 708, one or more network processor unit(s) 710 interconnected with one or more network input/output (I/O) interface(s) (network I/O interface(s) 712), one or more I/O interface(s) 714, and control logic 720. In various embodiments, instructions associated with logic for device 700 can overlap in any manner and are not limited to the specific allocation of instructions and/or operations described herein.

In at least one embodiment, processor(s) 702 is/are at least one hardware processor configured to execute various tasks, operations and/or functions for device 700 as described herein according to software and/or instructions configured for device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with device 700, and/or logic configured for memory element(s) 704 and/or storage 706. For example, any logic described herein (e.g., control logic 720) can, in various embodiments, be stored for device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of device 700 to communicate in order to exchange information and/or data. Bus 708 can be implemented with any architecture designed for passing control, data and/or information between processors, memory elements/storage, peripheral devices, and/or any other hardware and/or software components that may be configured for device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/ transmitters/transceivers, baseband processor(s)/modem(s), and/or other similar network interface driver(s) and/or controller(s) now known or hereafter developed to enable communications between device 700 and other systems, entities, etc. to facilitate operations for various embodiments described herein. In various embodiments, network I/O interface(s) 712 can be configured as one or more Ethernet port(s), WLAN interfaces, Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to device 700. For example, I/O interface(s) 714 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element’as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 7®)/Wi-Fi8® etc., IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method, comprising:
receiving, by a first access point having a transmit opportunity for a wireless channel in a wireless network, information indicative of buffered traffic at two or more other access points operating on the wireless channel;
determining, by the first access point, based on spatial isolation information, that the two or more other access points are compatible for concurrent transmissions during a portion of the transmit opportunity;
selecting, by the first access point, a coordinated spatial reuse configuration in which the two or more other access points are permitted to communicate concurrently during the portion of the transmit opportunity while the first access point refrains from transmitting user data during the portion; and
transmitting, by the first access point, control signaling that causes the two or more other access points to perform the concurrent transmissions during the portion of the transmit opportunity.

2. The method of claim 1, wherein the control signaling comprises a coordinated spatial reuse trigger frame transmitted by the first access point.

3. The method of claim 1, wherein the control signaling comprises a first trigger frame transmitted prior to a coordinated spatial reuse trigger frame.

4. The method of claim 3, wherein the first trigger frame identifies the two or more other access points permitted to communicate concurrently.

5. The method of claim 1, wherein the first access point does not transmit user data during the portion of the transmit opportunity allocated to the concurrent transmissions.

6. The method of claim 1, wherein the spatial isolation information is based on signal-to-interference ratio measurements between overlapping basic service sets.

7. The method of claim 1, wherein the spatial isolation information is received by the first access point via out-of-band signaling.

8. The method of claim 1, wherein the information indicative of buffered traffic identifies specific stations associated with the two or more other access points.

9. The method of claim 1, wherein the control signaling identifies specific stations permitted to participate in the concurrent transmissions.

10. The method of claim 1, wherein selecting the coordinated spatial reuse configuration is based on at least one of traffic priority, urgency, buffer occupancy, pathloss isolation, achievable modulation and coding scheme, or latency deadline.

11. The method of claim 1, wherein the control signaling specifies at least one of a transmit power or a modulation and coding scheme for the concurrent transmissions.

12. The method of claim 1, wherein the two or more other access points are not required to detect or decode transmissions from one another.

13. The method of claim 1, wherein the coordinated spatial reuse configuration is selected on a per-transmit-opportunity basis.

14. An apparatus, comprising:
one or more network interfaces to communicate with a wireless network;
a processor coupled to the one or more network interfaces and configured to execute one or more processes; and
a memory configured to store a process that is executable by the processor, the process comprising:
receiving, as a first access point having a transmit opportunity for a wireless channel in the wireless network, information indicative of buffered traffic at two or more other access points operating on the wireless channel;
determining, based on spatial isolation information, that the two or more other access points are compatible for concurrent transmissions during a portion of the transmit opportunity;
selecting a coordinated spatial reuse configuration in which the two or more other access points are permitted to communicate concurrently during the portion of the transmit opportunity while the first access point refrains from transmitting user data during the portion; and
transmitting control signaling that causes the two or more other access points to perform the concurrent transmissions during the portion of the transmit opportunity.

15. The apparatus of claim 14, wherein the control signaling comprises a first trigger frame transmitted prior to a coordinated spatial reuse trigger frame.

16. The apparatus of claim 15, wherein the first trigger frame identifies the two or more other access points permitted to communicate concurrently.

17. The apparatus of claim 14, wherein the first access point does not transmit user data during the portion of the transmit opportunity allocated to the concurrent transmissions.

18. The apparatus of claim 14, wherein selecting the coordinated spatial reuse configuration is based on at least one of traffic priority, urgency, buffer occupancy, or latency deadline.

19. The apparatus of claim 14, wherein the two or more other access points are not required to detect or decode transmissions from one another.

20. A non-transitory computer-readable medium storing computer-executable instructions that, when executed by one or more processors, cause a device to perform operations comprising:
receiving, as a first access point having a transmit opportunity for a wireless channel in a wireless network, information indicative of buffered traffic at two or more other access points operating on the wireless channel;
determining, based on spatial isolation information, that the two or more other access points are compatible for concurrent transmissions during a portion of the transmit opportunity;
selecting a coordinated spatial reuse configuration in which the two or more other access points are permitted to communicate concurrently during the portion of the transmit opportunity while the first access point refrains from transmitting user data during the portion; and
transmitting control signaling that causes the two or more other access points to perform the concurrent transmissions during the portion of the transmit opportunity.
